(19) United States
(12) Patent Application Publication
(10) Pub. No.: US 2016/0062997 A1
(43) Pub. Date: Mar. 3, 2016

(54) Serialized Child Associations in Parent Record

(71) Applicant: Weebly, Inc., San Francisco, CA (US)

(72) Inventor: Steven T. Roussey, San Francisco, CA (US)

(21) Appl. No.: 14/472,180

(22) Filed: Aug. 28, 2014

(51) Int. Cl. G06F 17/30

(52) U.S. Cl. CPC G06F 17/3048; G06F 17/30595

(57) ABSTRACT

A parent record is created, and the parent record includes a cache for children. Child records are created, and each child record belongs to a parent. Responsive to the creation or update of a child record, the parent record's cache is invalidated. To rebuild the parent record's cache, the child records are serialized and written into the parent record's cache. During a read operation, the parent record is read, including the parent record's cache of children, in a single database access. This results in a substantial savings of time as compared to retrieving the parent and the children from the database separately. Where the number of reads of the parent record greatly exceeds the number of changes to child records, serialized child associations in parent records enhances the efficiency of database access.

### BACKGROUND

This invention relates generally to database applications and in particular to improving the access speed of data in a database.

Data is often stored in a database in the form of tables or relations. A representation that describes the relations of the data stored in the database is referred to a relational model of the data.

Software applications, such as ecommerce applications, typically use an object representation of entities (e.g., products, orders, etc.) to describe identified items having attributes. This object representation of entities is referred to as an object model. The objects in the object model are manipulated through instructions provided using a programming language.

An object model can be mapped to a relational model of the data to allow transformation between the two representations. The mapping between the two representations is referred to as an Object Relational Mapping (“ORM”).

In some database schema, a one-to-many relationship exists between a parent record in the database and one or more levels of children associated with and belonging to the parent. For example, in the context of an e-commerce application, a product record may be considered a parent record which is often used as the basis of queries for data related to products. Each product may be associated with several stock keeping units (“SKUs”). For example, each SKU may be a slightly different configuration of the product, for example a different color, different material, a different form factor, and so on. The SKU records are considered children belonging to the parent product record. Each SKU is associated with exactly one product. Each SKU may further be associated with several files that provide additional data about the product identified by the SKU. The files are considered children belonging to the parent SKU record, which in turn belongs to a grandparent product record. Each file is associated with exactly one SKU.

In conventional database implementations, a parent record includes a pointer to each child record that belongs to it. Thus, to read a product record, first the database would be accessed to read the root product record itself. After obtaining the identity of the SKU child records from the root product record, each of the SKU child records of the root product record is separately read from the database. Thus, to read a parent record that has four child records associated with it, a minimum of two database read commands would be executed because the parent and the children need to be retrieved separately. In the case that each of the children of the parent also has children of its own, such as when each child SKU is associated with several grandchild files, the number of database reads needed to call up all of the information about a product grows, causing delays in service, particularly when multiple products are requested.

### SUMMARY

Embodiments of the invention serialize child associations and write them into the parent record in the database. A database operations module of an object relational mapping module performs database operations such as create, update, read, and delete. During a create operation, a parent record is created in a database, and the parent record includes a cache for children. Child records are created in the database, and each child record belongs to a parent record. Responsive to the creation, update, or deletion of a child record, the parent record's cache is invalidated. To rebuild the parent record's cache, the child records are serialized and written into the parent record's cache. Thus, changes to child records according to embodiments of the invention require more processing (i.e., additional database reads and writes) than would be required to perform these operations without the presence of the serialized child associations in the parent record. However, during a read operation, the parent record is read, including the parent record's cache of children, in a single database access. This results in a substantial savings of time as compared to retrieving the parent and the children from the database separately. Accordingly, for situations where the number of reads of the parent record greatly exceeds the number of changes to child records, serialized child associations in parent records enhances the efficiency of database access.

The features and advantages described in this summary and the following detailed description are not all-inclusive. Many additional features and advantages will be apparent to one of ordinary skill in the art in view of the drawings, specification, and claims.

### BRIEF DESCRIPTION OF THE DRAWINGS

FIG. 1 is diagram illustrating an overall system environment based on an object relational mapping, in accordance with an embodiment of the invention.

FIG. 2 is a diagram of an object relational mapping module of the sever system illustrated in FIG. 1, in accordance with an embodiment of the invention.

FIG. 3 is a flow chart illustrating create, change, and read operations performed by a database operations module of an object relational mapping module illustrated in FIG. 2, in accordance with another embodiment of the invention.

FIG. 4 illustrates example tables from the relational model, including serialized child associations in the parent records, in accordance with an embodiment of the invention.

FIG. 5 is a high-level block diagram illustrating an example of a computer for use in the system environment shown in FIG. 1 according to one embodiment of the present disclosure.

The Figures (FIGS.) and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures.

### DETAILED DESCRIPTION

### System Architecture

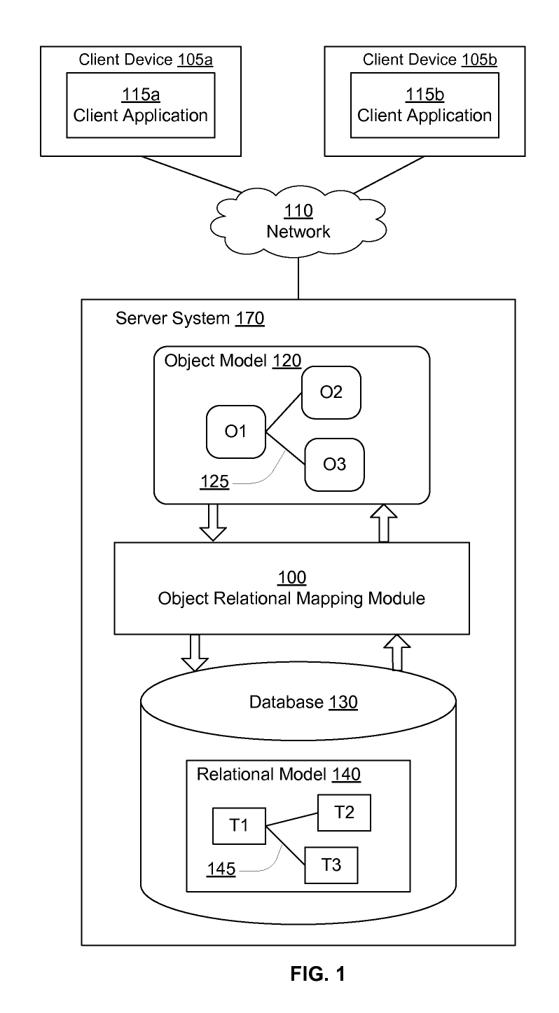

FIG. 1 is diagram illustrating an overall system environment based on an object relational mapping, in accordance with an embodiment of the invention. As shown in FIG. 1, the system environment includes two client devices 105a and 105b connected to server system 170 through a network 110. FIG. 1 and the other figures use like reference numerals to identify like elements. A letter after a reference numeral, such as “105a,” indicates that the text refers specifically to the element having that particular reference numeral. A reference numeral in the text without a following letter, such as “105,” refers to any or all of the elements in the figures bearing that reference numeral (e.g. “105” in the text refers to reference numerals “105a” and/or “105b” in the figures).

In one embodiment, the client devices 105 are conventional computer systems executing, for example, a Microsoft Windows-compatible operating system (OS), Apple OS, and/or a Linux distribution. In another embodiment, the client devices 105 can be devices having computer functionality, such as a personal digital assistant (PDA), mobile telephone, video game system, etc. The client device 105 includes a client application 115 configured to interact with the server system 170 via the network 110. The client application 115 may be an internet browser application. Network 110, may comprise any combination of local area and/or wide area networks, using both wired and/or wireless communication systems. In one embodiment, the network 110 uses standard communications technologies and/or protocols.

The server system 170 includes a database 130 that stores data processed by the server system 170. The data stored in database 130 is read and processed by the server system 170 for sending to the client device 105 for presentation via the client application 115. Furthermore, the server system 170 may receive data or instructions from the client device 105 that cause modifications to data stored in the database 130. The modifications to the data stored in the database 130 includes insertion of new data records, updates to existing data records, deletion of data records, and so on.

The server system 170 typically includes a database server (not shown in FIG. 1) which is a computer program that interacts with the database 130 and provides database services, for example, access to the data stored in the database. Database servers include commercially available programs, for example, database servers included with database management systems provided by ORACLE, SYBASE, MICROSOFT SQL SERVER, IBM's DB2, MYSQL, and the like. The server system 170 includes executable instructions that may be obtained by compiling or executing programs implemented using a programming language, for example, JAVA, PYTHON, PHP (hypertext processor), and so on.

The computing system used for hosting the server system 170 typically uses powerful processors, large memory, and fast input/output systems compared to a typical computing system used, for example, as a client device 105. The server typically has large secondary storage, for example, using a RAID (redundant array of independent disks) array.

FIG. 1 shows an embodiment in which the database 130 is a relational database having a relational model 140. The relational model 140 represents data as relations or tables comprising records. The database 130 may represent relations between tables, for example, relations based on foreign keys. FIG. 1 shows tables T1, T2, and T3 and relations 145 between the tables. Applications typically interact with the database 130 using an interface, for example, a structure query language (SQL). An example server system 170 may implement the backend of an e-commerce application that interacts with users via the client application 115. New data records may be inserted in the database 130 representing orders requested by users. Data may be updated, for example, inventory information as users purchase items. Furthermore, the enterprise managing the e-commerce system may update data by providing information describing new products (including new SKUs and files associated with the SKUs), by modifying information describing existing products, or by removing certain products.

The server system 170 maintains an object model 120 representing entities used by applications. The object model 120 represents entities as objects O1, O2, O3, and so on. For example, the server system implementing an e-commerce system may represent products, orders, images, transactions, and so on as objects. The objects in the object model may have relations 125 between them. For example, an object representing an order may be related to an object representing a product associated with the order. Each product object may be associated with one or more SKU (stock keeping unit) objects, and each SKU object may be associated with one or more files, and so on. The file object model has information about the file (like the location of the file on the server and disk, the size of the file, the format of the file, etc.).

The server system 170 includes an object relational mapping module 100 that maps data represented in the relational model 140 to objects in the object model 120 and vice versa. As an example, the server system 170 receives a request to read data corresponding to a particular object, for example, an object representing a product identified by name. The object relational mapping module 100 generates database queries to read the record corresponding to the identified product and generates an object based on the data obtained from the record. The database query may be a SELECT statement of SQL language.

As another example, the server system 170 receives a request to update an object, for example, a SKU object. The server system 170 performs an update to the object representation in the object model 120. In response to the update to the object representation, the object relational mapping 100 generates the corresponding update statements and executes the update statements to modify the corresponding SKU records of the database 130.

Similarly, the server system 170 may receive a request to create a new object, for example, an order object. The server system 170 creates the requested object in the object model 120. In response to the new object created in the object model 120, the object relational mapping 100 generates an insert statement and executes the insert statement to add a new record in the database 130 corresponding to the object created.

As another example, the server system 170 may receive a request to delete an object. The server system 170 deletes the requested object in the object model 120. In response to the deletion of the object in the object model 120, the object relational mapping 100 generates a delete statement and executes the delete statement to delete one or more record(s) of the database 130 corresponding to the object deleted.

The foregoing description has explained how the object relational mapping module 100 generally operates in the context of an ORM environment. The following figures are used to illustrate how serialized child associations are used in parent records to increase the efficiency of database operations by the object relational mapping module 100.

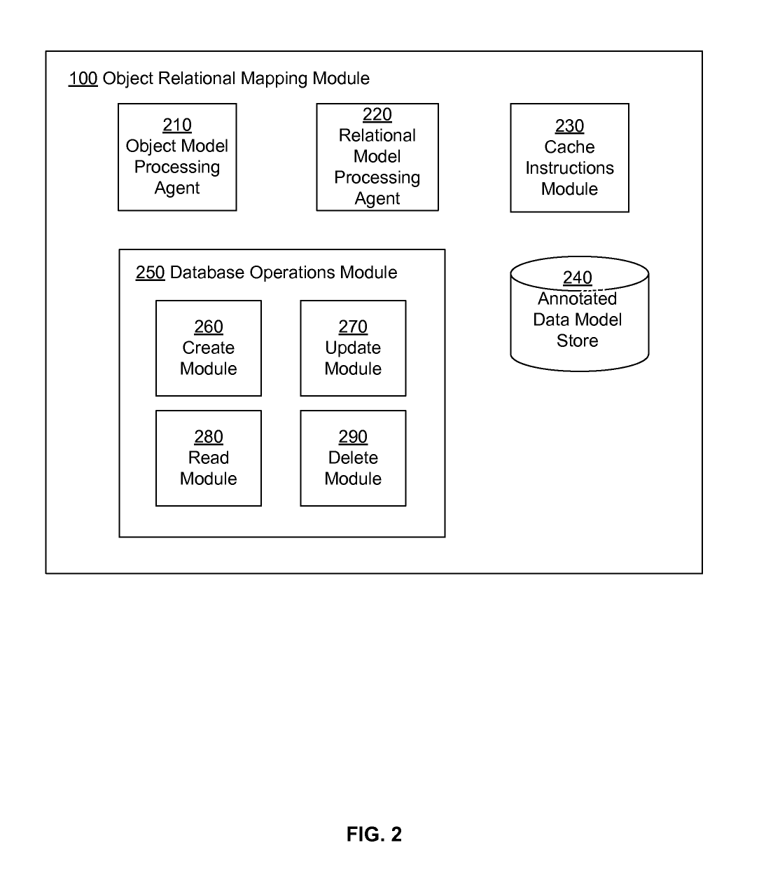

FIG. 2 is a diagram of an object relational mapping module 100 of the server system 170 illustrated in FIG. 1, in accordance with an embodiment of the invention. FIG. 2 shows that the object relational mapping module 100 includes an object model processing agent 210, a relational model processing agent 220, a cache instructions module 230, an annotated data model store 240, and a database operations module 250. In some embodiments, some of these modules may be represented as being independent of the object relational mapping module 100. Furthermore, a particular functionality or feature described herein as implemented by a particular module may be implemented by one or more other modules. In one embodiment, some of the modules may be part of a system different from the server system 170.

The object model processing agent 210 analyzes information describing the object model 120 to build a representation of the object model 120 comprising information used for performing the object relational mapping. In an embodiment, the information describing the object model 120 is available as comments included in source code that defines the corresponding objects, for example, using PHP language. In other embodiments, the information describing the object model 120 is available as a markup language, for example, XML (extensible markup language). The object model processing agent 210 generates a data structure describing the different types of objects available in the object model 120, their attributes and information describing each attribute. The specification may define the table that corresponds to a particular type of object and the columns that correspond to different attributes of the object. The object model processing agent 210 may further encounter instructions embedded in the comments regarding the relationship between a parent object and child objects and passes them to the cache instructions module 230. For example, the instructions may specify which children are good candidates for serializing into a cache in the parent record in the database to improve database access speed when the parent records are read. There is typically a one-to-many relationship between the parent and children, and each child belongs to a single parent, respectively. Thus, in one embodiment, the child objects are not reusable. Good candidates are instances where the parent record is expected to be the subject of frequent reads, and child records are expected to be infrequently added or updated or deleted. Because a penalty is paid to create the cache in the parent anytime a child record is added or updated or deleted, it is beneficial to have serialized child associations in the parent record only if the parent record is read more frequently than a child record is added or updated. Otherwise, the early investment to create the cache does not pay off in the long run.

The relational model processing agent 520 analyzes information describing the relational model 140 and builds a representation of the relational model 140 comprising information used for performing the object relational mapping. In an embodiment, the relational model processing agent 520 uses application programming interface (API) provided by database 130 that allows the relational model processing agent 520 to retrieve metadata describing different tables of the database 130. The relational model processing agent 520 obtains the list of tables that correspond to object types of the object model 120 from the object model processing agent 510. In an embodiment, the representation of the relational model 140 identifies different tables used by the object model processing agent 510 and columns of each table corresponding to mapped attributes of the object types.

The cache instructions module 230 receives from the object model processing agent 210 the instructions embedded in the comments regarding the relationship between a parent object and child objects. The instructions specify which children should be serialized into a cache in the parent record in the database to improve database access speed when the parent records are read. The cache instructions module 230 interprets the instructions and stores this information for use by the database operations module 250. Alternatively or additionally, the instructions are surfaced to a programmer who implements the instructions by modifying the database 130 accordingly.

Any changes to the data model generated as a result of the cache instructions may be stored in the annotated data model store 240. The annotated data model includes the information describing the tables corresponding to each object, the mappings of attributes to columns, and where appropriate, the mapping of children serialized into a parent record's cache. Accordingly, the annotated data model store 240 includes all the information to generate database statements corresponding to operations performed on the objects.

The database operations module 250 generates database statements corresponding to operations performed on objects in the object model 120. The database operations module 250 executes these generated database statements to either retrieve data from the database or to update data in the database so as to ensure that the data of the relational model 140 corresponds to the data of the object model 120. The database operations module 250 comprises create module 260, update module 270, read module 280, and delete module 290.

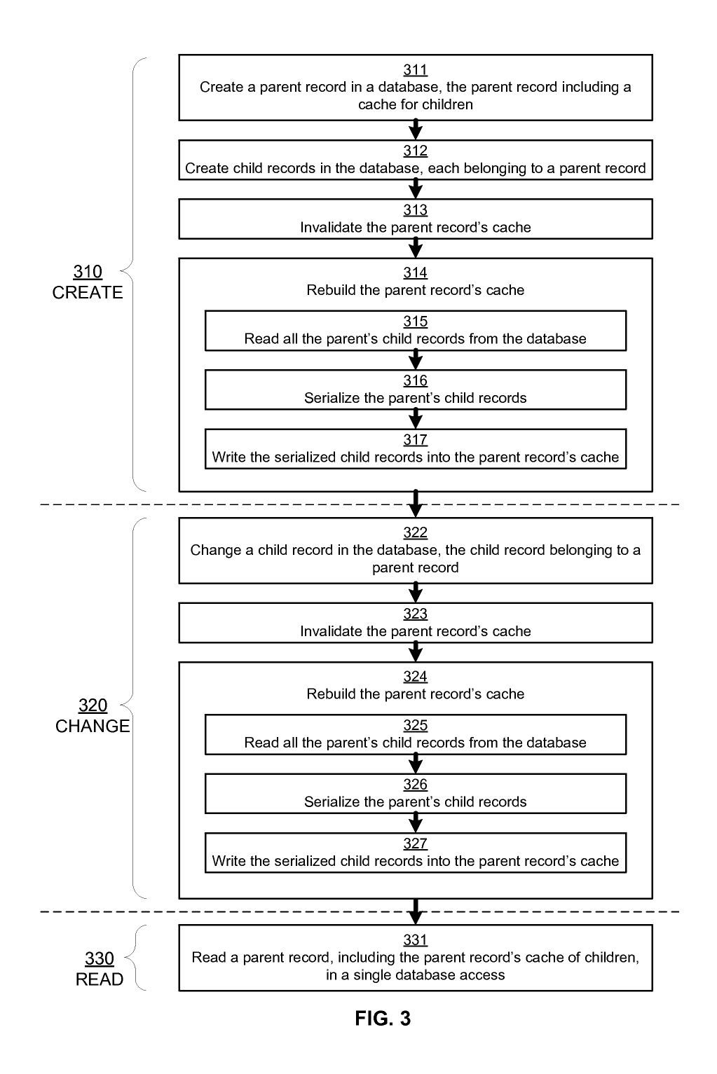

The create module 260 generates and executes database statements in response to creation of a new object in the object model 120. An example of this operation is described below with reference to create operation 310 illustrated in FIG. 3.

The update module 270 generates and executes database statements in response an update to an existing object in the object model 120. An example of this operation is described below with reference to change operation 320 illustrated in FIG. 3.

The read module 280 generates and executes database statements that read data from the database 130 and populate data in objects in the object model 120, for example, in response to a request to search for objects satisfying certain criteria. An example of this operation is described below with reference to read operation 330 illustrated in FIG. 3.

The delete module 390 generates and executes database statements in response a deletion of an existing object in the object model 120. The deletion of an existing object in the object model deletes the corresponding records in the database. The deletion of a parent can be configured to delete all the children records associated with the parent record to clean up the database. The deletion of a child will be discussed with respect to change operation 320 illustrated in FIG. 3.

### Example Methods

FIG. 3 is a flow chart illustrating create 310, change 320, and read 330 operations performed by a database operations module of an object relational mapping module illustrated in FIG. 2, in accordance with another embodiment of the invention. The create 310 operation refers to the creation of a parent record and its children. The change 320 operation refers to any change in a child record, including the creation of a new child, the change to data of the child record, or the deletion of a child record. The read operation refers reading the parent record, including the parent record's cache of children. The steps performed in these processes can be performed by different modules that those indicated. Furthermore, certain steps of these processes can be performed in different order than those indicated; for example, certain steps can be performed in parallel.

The method illustrated in FIG. 3 has been divided into three processes 310, 320, 330 for illustration purposes. After the create process 310 has executed, any number of change 320 and read 330 processes may be undertaken in any combination and any order. However, in aggregate, the investment made in the create 310 and change 320 process to build the parent record's cache is only worthwhile if the read process 330 executes more frequently than the change process 320. This technique excels in situations where data is accessed randomly and where the memory of the server is much smaller than the data set in storage.

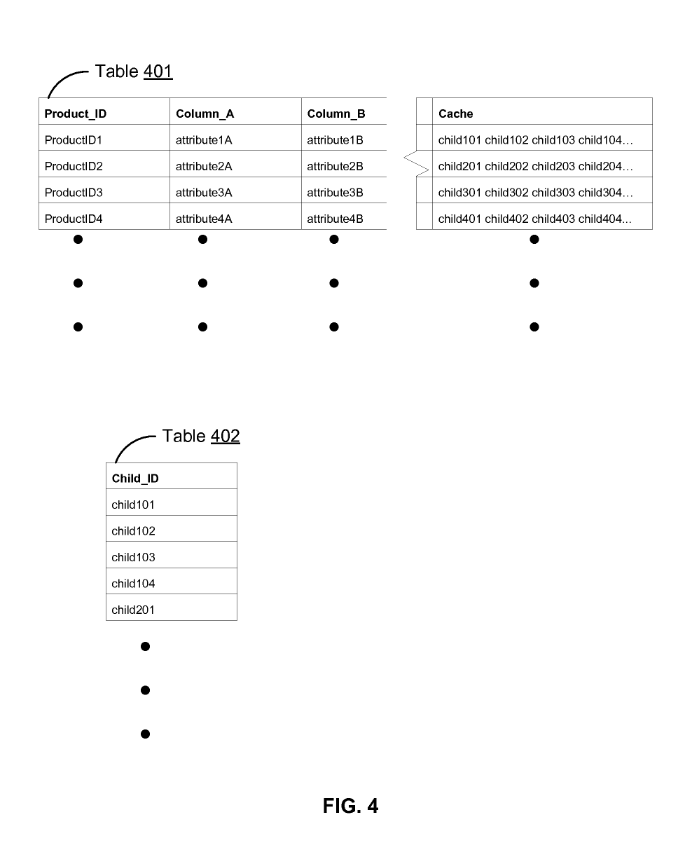

The create process 310 begins in step 311 by creating a parent record in a database, the parent record including a cache for children. For example, in the case of a product (i.e., the parent) associated with multiple SKUs (i.e., the children), a cache is created for holding the records of the SKUs. When first created, the cache values can be set to empty arrays until the child records are created, at which point the cache can be rebuilt. FIG. 4 illustrates example tables 401, 402 from the relational model, in accordance with an embodiment of the invention. Table 401 illustrates a product table. Each row the product table describes a single product, in terms of the attributes of Column_A, the attributes of Column_B, etc., and includes a column for a cache for children associated with the product. In this example, the children of the products may be stored in a separate table 402 related to table 401, but for ease of access, the children records are serialized and cached into the parent record. Although not illustrated in FIG. 4, multiple caches may be present in each parent record corresponding to different types of children associated with a parent. For example, SKU records may be serialized and cached in one column, and images corresponding to a product may be serialized and cached into another column, and so on. Moreover, nested caching is also allowed. For example, if a parent product is associated with SKU children, and each SKU child is associated with several respective files that are the children of the SKU, all of the descendants (i.e., children and grandchildren) of a parent can be serialized and written to the cache of the parent record.

In step 312, child records are created in the database, each child record belonging to exactly one parent record. For example, the SKU records are created, with each SKU belonging to exactly one product (i.e., the parent).

In step 313, responsive to the new child record, the parent record's cache is invalidated. In one embodiment, since the child in the ORM context is known as belonging to exactly one parent, the creation of a child can trigger the corresponding parent record's cache as being marked as invalidated, for example by setting a flag.

In step 314, the parent record's cache is rebuilt. Invalidated caches are rebuilt so that subsequent reads of the parent record, described below with reference to process 330, can benefit from enhanced efficiency. Rebuilding the parent record's cache comprises steps 315-317. In step 315, all of the parent's child records are read from the database, unless the children are already in memory as object models. This includes both the recently-created child record as well as that child's sister records. In step 316, the parent's child records are serialized for compact storage in the parent record's cache. Any serializing function known to those of skill in the art can be used to generate a serialized representation of the data in all of the child records for insertion into the parent's record, for example in a cache column. In step 317, the serialized child records are written into the parent record's cache, for example in the cache column of the parent's record. Thus, the parent record's cache is rebuilt containing all of the most up to date child records. The parent record's cache is no longer invalid, and any mark of invalidation, such as a flag, is cleared.

The change process 320 begins in step 322 by changing a child record in the database, the child record belonging to a parent record. For example, a SKU belonging to a parent product might change. The change is implemented in the object model, which is translated to update the SKU record in the database.

In step 323, responsive to the updated child record, the parent record's cache is invalidated. This may be signaled by setting a flag. The parent record's invalidated cache contains the old SKU which is now outdated. Optionally, the parent record's cache can be rebuilt immediately, or upon the next attempted read process 330.

In step 324, the parent record's cache is rebuilt. Invalidated caches are rebuilt so that subsequent reads of the parent record, described below with reference to process 330, can benefit from enhanced efficiency. Rebuilding the parent record's cache may comprise steps 325-327, which are the same as steps 315-317 described above. In step 325, all of the parent's child records are read from the database, or the cache is used to build the object models and update the child record in question. In step 326, the parent's child records are serialized for compact storage in the parent record's cache. In step 327, the serialized child records are written into the parent record's cache, for example in the cache column of the parent's record. The parent record's cache is no longer invalid, and any mark of invalidation, such as a flag, is cleared.

The extra investments to build and update the parent's cache of children described above with reference to the create process 310 and the change process 320 make the read process 330 very efficient. In step 331, the parent record is read, including the parent record's cache of children, in a single database access. The serialized child records from the parent's cache are de-serialized and the values are available immediately for processing, without needing to undertake several separate reads of the database to retrieve the child records separately. Thus, the read process of the entire parent record, including the child records belonging to the parent, is performed with greater ease and efficiency than performing several database reads as would be conventionally required.

In addition, if at any time during an attempted read 330, it is found that the parent record contains an invalid cache (which may be signaled with an invalid flag described above) the read process 330 can fail over to performing the regular look ups of the children through additional database accesses as would be conventionally performed without the presence of the cache in the parent record. Accordingly, at worst, when the cache is invalid, the read process 330 is only as slow as it would be under a conventional read process, and the cache can be rebuilt at read time to offer faster reads in the future.

### Computer Architecture

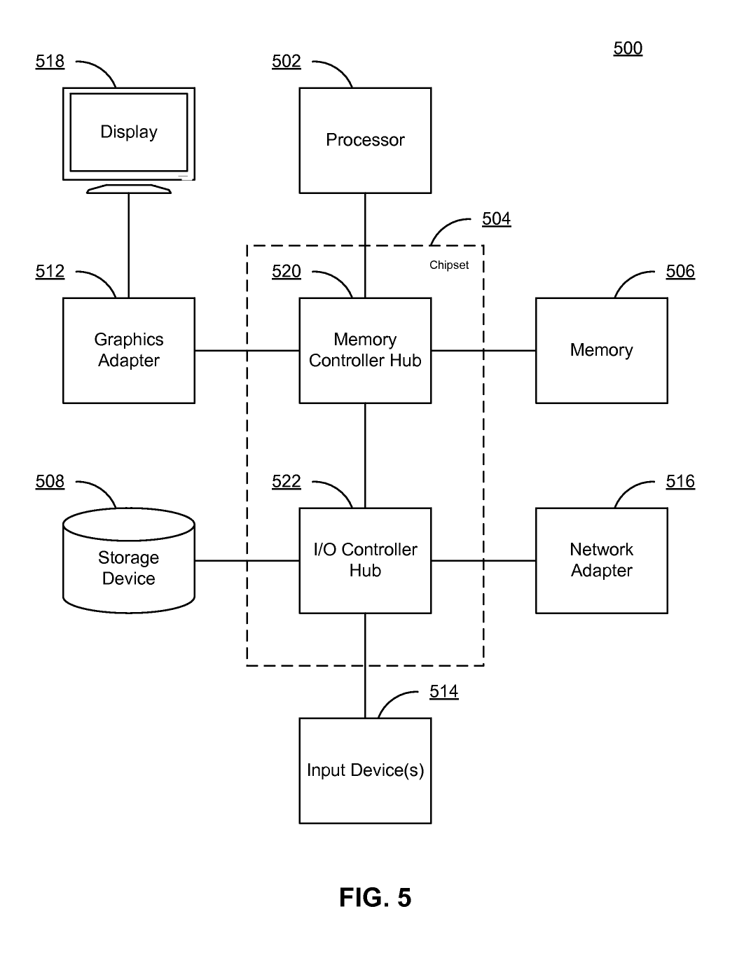

FIG. 5 is a high-level block diagram of the components of a computing system 500 for use, for example, as the server system 170 or the client device 105 shown in FIG. 1, in accordance with one embodiment. The computing system 500 includes at least one processor 502 coupled to a chipset 504. Also coupled to the chipset 504 are a memory 506, a storage device 508, a graphics adapter 512, input device(s) 514, and a network adapter 516. A display 518 is coupled to the graphics adapter 512. In one embodiment, the functionality of the chipset 504 is provided by a memory controller hub 520 and an input/output (I/O) controller hub 522. In another embodiment, the memory 506 is coupled directly to the processor 502 instead of the chipset 504.

The processor 502 is an electronic device capable of executing computer-readable instructions held in the memory 506. In addition to holding computer-readable instructions, the memory 506 also holds data accessed by the processor 502. The storage device 508 is a non-transitory computer-readable storage medium that also holds computer readable instructions and data. For example, the storage device 508 may be embodied as a solid-state memory device, a hard drive, compact disk read-only memory (CD-ROM), a digital versatile disc (DVD), or a BLU-RAY disc (BD). The input device(s) 514 may include a pointing device (e.g., a mouse or track ball), a keyboard, a touch-sensitive surface, a camera, a microphone, sensors (e.g., accelerometers), or any other devices typically used to input data into the computer 500. The graphics adapter 512 displays images and other information on the display 518. In some embodiments, the display 518 and an input device 514 are integrated into a single component (e.g., a touchscreen that includes a display and a touch-sensitive surface). The network adapter 516 couples the computing device 500 to a network, such as the network 101.

As is known in the art, a computer 500 can have additional, different, and/or other components than those shown in FIG. 5. In addition, the computer 500 can lack certain illustrated components. In one embodiment, a computer 500 acting as a server may lack input device(s) 514, a graphics adapter 512, and/or a display 518. Moreover, the storage device 508 can be local and/or remote from the computer 500. For example, the storage device 508 can be embodied within a storage area network (SAN) or as a cloud storage service.

As is known in the art, the computer 500 is adapted to execute computer program modules for providing functionality described herein. As used herein, the term “module” refers to computer program logic utilized to provide the specified functionality. Thus, a module can be implemented in hardware, firmware, and/or software. In one embodiment, computer program modules are stored on the storage device 508, loaded into the memory 506, and executed by the processor 502.

As used herein, a computer program product comprises one or more computer program modules that operate in conjunction to provide the functionality described herein. Thus, a computer program product may be stored on the storage device 508, loaded into the memory 506, and executed by the processor 502 to provide the functionality described herein.

Embodiments of the physical components described herein can include other and/or different modules than the ones described here. In addition, the functionality attributed to the modules can be performed by other or different modules in other embodiments. Moreover, this description occasionally omits the term “module” for purposes of clarity and convenience.

### Additional Configuration Considerations

Some portions of above description describe the embodiments in terms of algorithmic processes or operations. These algorithmic descriptions and representations are commonly used by those skilled in the data processing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the disclosure. This description should be read to include one or at least one and the singular also includes the plural unless it is obvious that it is meant otherwise.

Upon reading this disclosure, those of skill in the art will appreciate still additional alternative structural and functional designs for systems disclosed herein. Thus, while particular embodiments and applications have been illustrated and described, it is to be understood that the invention is not limited to the precise construction and components disclosed herein and that various modifications, changes and variations which will be apparent to those skilled in the art may be made in the arrangement, operation and details of the method and apparatus disclosed herein without departing from the spirit and scope as defined in the appended claims.

What is claimed is:

1. A method for improving data access efficiency in an object-relational mapping environment by using a parent record's cache of children belonging to the parent, the method comprising:
changing a child record in a database, the child record belonging to a parent record and being one of a plurality of children belonging to the parent record;
responsive to the changed child record, invalidating the parent record's cache;
rebuilding the parent record's cache, comprising:
serializing the parent's child records; and
writing the serialized child records into the parent record's cache; and
reading the parent record, including the parent record's cache of children, in a single database access.

2. The method of claim 1, wherein rebuilding the parent record's child records further comprises reading all of the parent's child records from the database.

3. The method of claim 1, further comprising:
creating the parent record in the database, the parent record including a cache for children of the parent record; and
creating child records in the database, each child record belonging to a respective parent record in the database.

4. The method of claim 1, wherein invalidating the parent record's cache comprises setting a flag.

5. The method of claim 4, wherein rebuilding the parent record's cache further comprises clearing the flag after writing the serialized child records into the parent record's cache.

6. The method of claim 1, wherein steps of the method are repeatedly performed comparatively different numbers of times, and the total number times reading the parent record is performed greatly exceeds the total number of times changing the child record is performed.

7. The method of claim 1, wherein the parent record's cache is one of a plurality of parent record caches, each of the plurality of parent record caches corresponding to a different type of children associated with the parent.

8. The method of claim 1, wherein rebuilding the parent record's cache comprises:
reading all of the parent's descendant records from the database;
serializing the parent's descendant records; and
writing the serialized descendant records into the parent record's cache; and
wherein reading the parent record, including the parent record's cache of children, in a single database access comprises reading the parent record, including the parent record's cache of descendants, in a single database access.

9. The method of claim 1, wherein the parent's cache is implemented as a column in a table describing a parent.

10. The method of claim 1, further comprising:
de-serializing the serialized child records read from the parent record's cache to obtain values of the child records.

11. A computer-implemented system for improving data access efficiency in an object-relational mapping environment by using a parent record's cache of children belonging to the parent, the system comprising:
a computer processor; and
a non-transitory computer-readable storage medium storing instructions configured to execute on the computer processor, the instructions for:
changing a child record in a database, the child record belonging to a parent record and being one of a plurality of children belonging to the parent record;
responsive to the changed child record, invalidating the parent record's cache;
rebuilding the parent record's cache, comprising:
serializing the parent's child records; and
writing the serialized child records into the parent record's cache; and
reading the parent record, including the parent record's cache of children, in a single database access.

12. The system of claim 11, wherein rebuilding the parent record's child records further comprises reading all of the parent's child records from the database.

13. The system of claim 11, wherein the non-transitory computer-readable storage medium further comprises instructions for:
creating the parent record in the database, the parent record including a cache for children of the parent record; and
creating child records in the database, each child record belonging to a respective parent record in the database.

14. The system of claim 11, wherein invalidating the parent record's cache comprises setting a flag.

15. The system of claim 14, wherein rebuilding the parent record's cache further comprises clearing the flag after writing the serialized child records into the parent record's cache.

16. The system of claim 11, wherein the instructions are repeatedly executed comparatively different numbers of times, and the total number times reading the parent record is executed greatly exceeds the total number of times changing the child record is executed.

17. The system of claim 11, wherein the parent record's cache is one of a plurality of parent record caches, each of the plurality of parent record caches corresponding to a different type of children associated with the parent.

18. The system of claim 11, wherein rebuilding the parent record's cache comprises:
reading all of the parent's descendant records from the database;
serializing the parent's descendant records; and
writing the serialized descendant records into the parent record's cache; and
wherein reading the parent record, including the parent record's cache of children, in a single database access comprises reading the parent record, including the parent record's cache of descendants, in a single database access.

19. The system of claim 11, wherein the parent's cache is implemented as a column in a table describing a parent.

20. The system of claim 11, wherein the non-transitory computer-readable storage medium further comprises instructions for:
de-serializing the serialized child records read from the parent record's cache to obtain values of the child records.
